(19) United States
(12) Patent Application Publication
(10) Pub. No.: US 2012/0170503 A1
(43) Pub. Date: Jul. 5, 2012

(54) METHOD AND APPARATUS FOR CONTROLLING NETWORK ACCESS IN A MULTI-TECHNOLOGY WIRELESS COMMUNICATION SYSTEM

(75) Inventors: Sean S. Kelley, Barrington, IL (US); Luis Lopes, Swindon (GB); Christopher R. Schmidt, Pinole, CA (US)

(73) Assignee: MOTOROLA, INC., Libertyville, IL (US)

(21) Appl. No.: 12/982,154

(22) Filed: Dec. 30, 2010

(51) Int. Cl. H04L 12/56; H04H 20/71

(52) U.S. Cl. 370/312; 370/389

(57) ABSTRACT

A method and apparatus is provided for controlling network access in a communication system comprising a packet data network and a circuit switched network. The packet data network receives, from the circuit switched network, a message indicating that the circuit switched network is congested. In response to receiving the indication, the packet data network broadcasts a message informing that access to one or more services of the circuit switched network is restricted. In various embodiments, the message received from the circuit switched network may include access class barring parameters identifying one or more classes of user equipment or service classes that are one or more of being barred from accessing the circuit switched network or whose access to the circuit switched network is being reduced and/or may identify one or more coverage areas or access nodes of the circuit switched network where access is being restricted.

### FIELD OF THE INVENTION

The present invention relates generally to wireless communication systems, and more specifically to controlling network access in a wireless communication system implementing multiple air interface technologies.

### BACKGROUND OF THE INVENTION

The evolution of wireless communications has resulted in a proliferation of networks of different technologies and corresponding air interfaces. As a result, when a wireless user equipment (UE) establishes a communication session, multiple technologies and air interfaces, and correspondingly multiple radio access networks (RANs), may be available and accessible for a voice portion of the session. For example, the UE may be able to concurrently access a legacy circuit switched network (for example, a second generation (2G) or 2.5G network), such as a CDMA (Code Division Multiple Access) 1X or a CDMA 1xRTT (1X Radio Transmission Technology) network or a GSM (Global System for Mobile communications) network providing primarily circuit voice service, or a later generation packet data network, such as a 3GPP LTE (Third Generation Partnership Project Long Term Evolution) network, a 3GPP2 UMB (Third Generation Partnership Project 2 Ultra Mobile Broadband) network, a WiMAX network, or a Wireless Fidelity (Wi-Fi) network based on IEEE 802 standards, providing packet switched data services. The packet data network also may provide Voice over Internet Protocol (VoIP) services.

When a communication system includes both a packet data network and a circuit switched network, it may be beneficial to system performance for a UE is operating in the packet data network to receive incoming voice calls and/or route outgoing voice calls via the circuit switched network. This is known as circuit switched fallback (CSFB). For example, channel conditions associated the circuit switched network may be more favorable than channel conditions associated with the packet data network or a system operator may prefer, for bandwidth or cost reasons, to establish the voice session with the circuit switched network. However, a problem with CSFB is that the packet data network typically does not know the level of congestion of the circuit switched network. As a result, an attempt to establish a call in the circuit switched network may add to congestion of an already congested network, causing the call attempt to fail or the call to be dropped and/or may detrimentally impact a quality of other on-going calls in the circuit switched network.

Therefore, a need exists for a method and apparatus for controlling access to a circuit switched network for a UE active in a packet data network in a wireless communication system implementing circuit switched fallback.

### BRIEF DESCRIPTION OF THE DRAWINGS

FIG. 1 is a block diagram of a wireless communication system in accordance with various embodiments of the present invention.

FIG. 2 is a block diagram of a user equipment of FIG. 1 in accordance with an embodiment of the present invention.

FIG. 3 is a block diagram of a packet data wireless access node of FIG. 1 in accordance with an embodiment of the present invention.

FIG. 4 is a block diagram of a circuit switched wireless access node of FIG. 1 in accordance with an embodiment of the present invention.

FIG. 5 is a block diagram of a Mobility Management Entity of FIG. 1 in accordance with an embodiment of the present invention.

FIG. 6 is a block diagram of a Interworking Solution Function of FIG. 1 in accordance with an embodiment of the present invention.

FIG. 7 is a block diagram of a Mobile Switching Center of FIG. 1 in accordance with an embodiment of the present invention.

FIG. 8 is a logic flow diagram illustrating a method executed by the communication system of FIG. 1 in restricting access to services of a circuit switched network of the communication system by a user equipment active in a packet data network of the communication system in accordance with various embodiments of the present invention.

FIG. 9 is a logic flow diagram illustrating a method executed by the communication system of FIG. 1 in providing for a release of restricted access to services of a circuit switched network of the communication system by a user equipment active in a packet data network of the communication system in accordance with various embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need that exists for a method and apparatus for controlling access to a circuit switched network for a UE active in a packet data network in a wireless communication system implementing circuit switched fallback, a method and apparatus is provided for controlling network access in a communication system comprising a packet data network and a circuit switched network. The packet data network receives, from the circuit switched network, a message indicating that the circuit switched network is congested. In response to receiving the indication, the packet data network broadcasts a message informing that access to one or more services of the circuit switched network is restricted. In various embodiments, the message received from the circuit switched network may include access class barring parameters identifying one or more classes of user equipment or service classes that are one or more of being barred from accessing the circuit switched network or whose access to the circuit switched network is being reduced and/or may identify one or more coverage areas or access nodes of the circuit switched network where access is being restricted.

Generally, an embodiment of the present invention encompasses a method for controlling network access in a multi-technology wireless communication system comprising a packet data network and a circuit switched network. The method includes serving, by the packet data network, a user equipment, receiving, by the packet data network from the circuit switched network, an indication that the circuit switched network is congested, and broadcasting, by the packet data network, a message informing that access to one or more services of the circuit switched network is restricted.

Another embodiment of the present invention encompasses a method for controlling network access in a multi-technology wireless communication system comprising a packet data network and a circuit switched network. The method includes receiving from the packet data network, by a user equipment active in the packet data network, a message informing that access to one or more services of the circuit switched network is restricted and, in response to receiving the message, limiting, by the user equipment, attempts to establish a voice call via the circuit switched network.

Yet another embodiment of the present invention encompasses an apparatus that controls network access in a multi-technology wireless communication system comprising a packet data network and a circuit switched network. The apparatus includes an at least one memory device that is configured to maintain a list of packet data network access nodes and a mapping of one or more of coverage areas and access nodes of the circuit switched network to corresponding coverage areas and access nodes of the packet data network. The apparatus further includes a processor that is configured to receive, in the packet data network and from the circuit switched network, a message indicating that the circuit switched network is congested and, in response to receiving the message, convey a message to an access node of the packet data network instructing the access node to broadcast a message informing that access to one or more services of the circuit switched network is restricted.

Still another embodiment of the present invention encompasses a user equipment capable of operating in a multi-technology wireless communication system comprising a packet data network and a circuit switched network. The user equipment includes a processor configured to, when active in the packet data network, receive from the packet data network a message informing that access to one or more services of the circuit switched network is restricted and, in response to receiving the message, limit attempts to establish a voice call via the circuit switched network.

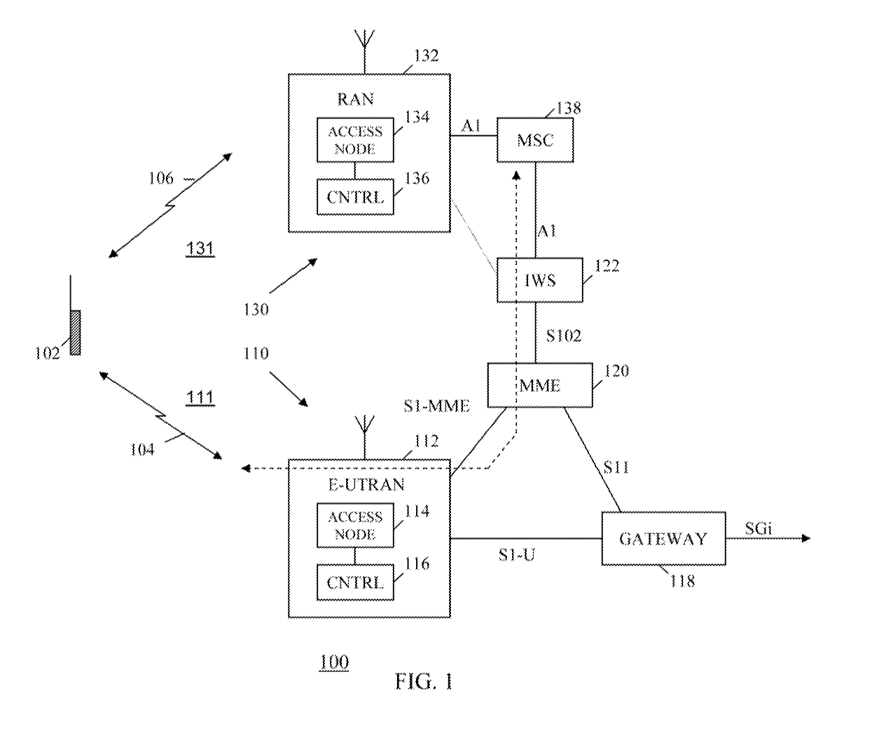

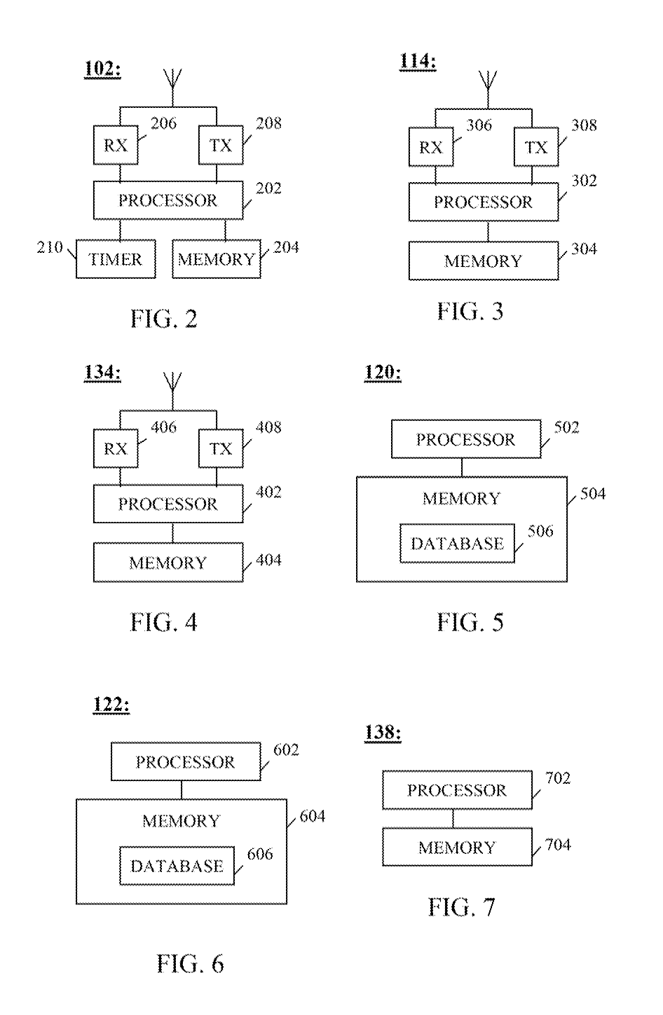

Turning now to the drawings, the present invention may be more fully described with reference to FIGS. 1-9. FIG. 1 is a block diagram of a wireless communication system 100 in accordance with various embodiments of the present invention. Communication system 100 includes a wireless user equipment (UE) 102, for example but not limited to a cellular telephone, a radiotelephone, or a Personal Digital Assistant (PDA), personal computer (PC), or laptop computer equipped for wireless voice communications. UE 102 is capable of engaging in a packet data voice call with a packet data network 110 of communication system 100 and is further capable of engaging in a circuit switched voice call with a circuit switched network 130 of the communication system, and more particularly is capable of communicating with a Radio Access Network (RAN) 132 of the circuit switched network via a legacy protocol, such as a CDMA (Code Division Multiple Access) 1X or a CDMA 1xRTT (1X Radio Transmission Technology) protocol, and is capable of communicating with a RAN 112 of the packet data network via a later generation protocol, for example, via a 3GPP LTE (Third Generation Partnership Project Long Term Evolution) protocol.

Circuit switched network 130 includes a circuit switched Radio Access Network (RAN) 132. RAN 132 includes a circuit switched wireless access node 134, for example, a Base Transceiver Station (BTS), operably coupled to a controller 136, for example, a Base Station Controller (BSC). Circuit switched network 130 further includes a Mobile Switching Center (MSC) 138 that is coupled to RAN 132, preferably via an A1 interface, and an Interworking Solution Function (IWS) 122 coupled to the MSC. In various embodiments of the present invention, IWS 122 further may be coupled to one or more of access node 134 and controller 136. While IWS 122 is depicted as an entity separate from access node 134 and controller 136, in various embodiments of the invention IWS 122 may be included in RAN 132 and may be implemented by one or more of access node 134 and controller 136.

Packet data network 110 includes a packet data RAN 112, such as an E-UTRAN (Evolved Universal Terrestrial Radio Access Network). RAN 112 includes a packet data wireless access node 114, for example, a Node B or an evolved Node B (eNodeB), coupled to a controller 116, such as a Radio Network Controller (RNC). However, in other embodiments of the present invention, the functionality performed by wireless access node 114 and controller 116 may be performed by a single entity. Packet data network 110 further includes a Gateway 118 that is coupled to RAN 112, preferably via an S1-U interface, and a Mobility Management Entity (MME) 120 coupled to RAN 112 and Gateway 118. Preferably, Gateway 118 comprises one or more of a Serving Gateway (Serving GWG) and a Public Data Network (PDN) Gateway and is coupled to MME 120 via an S11 interface.

Each of RAN 112 and RAN 132 provides wireless communication services to users equipment (UEs) located in a respective coverage area 111, 131 of the RAN via a respective air interface 104, 106. Each air interface 104, 106 includes a forward link that includes a pilot channel, at least one forward link traffic channel, and forward link common and dedicated signaling channels. Each air interface 104, 106 further includes a reverse link that includes at least one reverse link traffic channel, reverse link common and dedicated signaling channels, and an access channel. For purposes of the present invention, it is assumed herein that coverage area 111 of access node 114 of packet data network 110 substantially corresponds with the coverage area 131 or access node 134 of circuit switched network 130, that is, that there is a partial or a complete overlap of coverage area 111 with coverage area 131 such that a UE residing in at least a portion of coverage area 111 and provided wireless services by RAN 110, and in particular by access node 114, also can be provided wireless services by RAN 130 and in particular by access node 134, and similarly a UE residing in at least a portion of coverage area 131 of RAN 130 and provided wireless services by RAN 130, and in particular by access node 134, also can be provided wireless services by RAN 110, and in particular by access node 114 (herein also referred to as corresponding access nodes and/or coverage areas).

Packet data network 110 and circuit switched network 130, and more particularly MME 120 and MSC 138, communicate with each other via IWS 122. IWS 122 provides an interworking function between packet data network 110 and circuit switched network 130. For example, when circuit switched network 110 is a CDMA 1xRTT network, IWS 122 supports A1/A1p signaling with the circuit switched network. IWS 122 further interfaces to packet switched network 110 and in particular to MME 120, for example, via an S102 interface or an A21 interface, and supports packet data signaling with the packet data network. For example, IWS 122 may encapsulate circuit switched network signaling in packet data network signaling, thereby permitting a circuit switched message to be transported over the air to a UE in packet data network 110. IWS 122 further provides an interworking function allowing packet data network messaging to be conveyed to a UE in circuit switched network 130 by encapsulating the packet data network signaling in circuit switched network signaling, for example, permitting a packet data network message to be transported over circuit switched network 110 to a UE as a circuit switched network Data Burst or signaling message. Together, access nodes 114 and 134, controllers 116 and 136, Gateway 118, MME 120, IWS 122, and MSC 138 may be collectively referred to as a communications network, or infrastructure, of communication system 100.

The above-listed interfaces are all known in the art and will not be described in greater detail herein. Furthermore, although single interfaces have been described herein between many of the network elements of communication system 100, each interconnection among elements may comprise multiple interconnections and/or interfaces, such as one or more of a signaling interface and a bearer interface or path, such a path for an exchange of voice information.

Referring now to FIGS. 2-7, architectures of UE 102, access nodes 114 and 134, MME 120, IWS 122, and MSC 138, respectively, are provided in accordance with an embodiment of the present invention. Each of UE 102, access nodes 114 and 134, MME 120, IWS 122, and MSC 138 includes a respective processor 202, 302, 402, 502, 602, 702 such as one or more microprocessors, microcontrollers, digital signal processors (DSPs), customized processors, field programmable gate arrays (FPGAs), or combinations thereof or such other devices known to those having ordinary skill in the art, which processor is configured to execute the functions described herein as being executed by UE, eNodeB, MME, IWS and MSC.

Each of UE 102, access nodes 114 and 134, MME 120, IWS 122, and MSC 138 further includes a respective at least one memory device 204, 304, 404, 504, 604, 704 such as but are not limited to a hard disk, a CD-ROM, an optical storage device, a magnetic storage device, random access memory (RAM), dynamic random access memory (DRAM), a ROM (Read Only Memory), a PROM (Programmable Read Only Memory), an EPROM (Erasable Programmable Read Only Memory), an EEPROM (Electrically Erasable Programmable Read Only Memory) a Flash memory, or equivalents thereof that is coupled to the processor and that maintains data and programs that may be executed by the associated processor and that allows the UE to perform all functions necessary to operate in communication system 100. When IWS 122 is implemented by access node 134 or controller 136, the IWS may implemented by a processor of the access node (that is, processor 402) or controller based on instructions maintained in an associated at least one memory device of the access node (that is, at least one memory device 404) or controller.

The at least one memory device 204 of UE 102 further may maintain preprogrammed information that facilitates a switching between networks 110 and 130 and a listing of circuit switched network access restriction parameters and/or packet data network access restriction parameter as are described in greater detail below, thereby facilitating the UE's implementation of whatever restrictions to access of circuit switched network 130 of which the UE is informed by packet data network 110. Additionally, the at least one memory device 504 of MME 120 further maintains a database 506 comprising list of packet data network 110 access nodes served by the MME and a mapping of coverage areas and/or access node of circuit switched network 130 to substantially corresponding coverage areas/access nodes of packet data network 110. The coverage areas/access nodes may be identified by any geographic area identifier or access node identifier known in the art, such as Cell Identifiers, Sector Identifiers, Base Station Identifiers, Tracking Area Identifiers, Location Area Identifiers, and so on. For example, such mapping information may include a one-to-one mapping of circuit switched network 130 sectors to packet data network 110 cells (for example, where a circuit switched network 130 sector uses the same antennas as a packet data network 110 cell), a one-to-many mapping of circuit switched network 130 sectors to packet data network 110 cells (for example, where a circuit switched network 130 sector is larger than a packet data network 110 cell and covers multiple packet data network 110 cells), or a many-to-one mapping of circuit switched network 130 sectors to packet data network 110 cells (for example, where a packet data network 110 cell is larger than a circuit switched network 130 sector and covers multiple circuit switched network 130 sectors). Database 506 of MME 120 further maintains a mapping of access nodes in communication system 100, such as access nodes 114 and 134, to IWSs serving such access nodes, such as access nodes 114 and 134 and corresponding serving IWS 122. The above-referenced mappings may be pre-programmed into MME 120 or may be dynamically determined by the MME by monitoring identifiers in messaging routed to the MME by the access nodes.

UE 102 further includes at least one radio frequency (RF) receiver 206 and at least one RF transmitter 208 for wirelessly receiving signals from, and transmitting signals to, the infrastructure of communication system 100, and in particular both RAN 112 and RAN 132. For example, UE 102 may communicate with one or the other of access nodes 114 and 134, or communicate with both access nodes 114 and 134 simultaneously. Similarly, each of access nodes 114 and 134 further includes a respective at least one RF receiver 306, 406 and a respective at least one RF transmitter 308, 408 for wirelessly receiving signals from, and transmitting signals to, UEs serviced by the access node, such as UE 102.

Unless otherwise specified herein, the functionality described herein as being performed by UE 102, access nodes 114 and 134, MME 120, IWS 122, and MSC 138 is implemented with or in software programs and instructions stored in the respective at least one memory device 204, 304, 404, 504, 604, 704 associated with the UE, access node, MME, IWS, and MSC and executed by a processor 202, 302, 402, 502, 602, 702 associated with the UE, access node, MME, IWS, and MSC. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the UE, access node, MME, and MSC. Based on the present disclosure, one skilled in the art will be readily capable of producing and implementing such software and/or hardware without undo experimentation.

In order for UE 102 to engage in a communication session in either packet data network 110 or circuit switched network 130, each of UE 102, packet data network 110, and circuit switched network 130 operates in accordance with known wireless telecommunications protocols. Circuit switched network 130 is a legacy communication system, such as a CDMA 1X or a CDMA 1xRTT (1X Radio Transmission Technology) network, that provides circuit switched communication services to subscribers serviced by the network (it may also provide packet data services) and that operates in accordance with the CDMA 1X or CDMA 1xRTT standards. Packet data network 130 is a later generation communication system, preferably a 3GPP LTE communication system, that provides packet data communication services to subscribers serviced by the network; however, other applicable packet data networks include 3GPP2 UMB and WiMAX packet data networks. To ensure compatibility, radio system parameters and call processing procedures are specified by the standards, including call processing steps that are executed by an UE and a base station subsystem or other access network serving the UE and between the base station subsystem or other access network and associated infrastructure. However, those of ordinary skill in the art realize that packet data network 130 may operate in accordance with any one of a variety of wireless packet data communication standards that support multimedia packet data-based communication sessions, such as the 3GPP2 UMB standards, the WiMAX standards, and the IEEE (Institute of Electrical and Electronics Engineers) 802.xx standards, for example, the 802.11, 802.15, or 802.16 or 802.20 standards, and that circuit switched network 110 may operate in accordance with any one of a variety of well-known legacy wireless telecommunication standards, such as the Global System for Mobile communications (GSM) standards, that provide circuit switched communication services.

In communication system 100, while UE 102 is operating in packet data network 110, it may be desirable to establish a voice call or a voice portion of a communication session of the UE via circuit switched network 130. For example and as is known in the art, while roaming in communication system 100 and being serviced by RAN 112, UE 102 may receive a stronger signal from RAN 132. Typically signal strengths are determined by a UE, such as UE 102, measuring a pilot channel associated with the RAN. By way of another example, the costs associated with operating UE 102 on circuit switched network 130 may be less than the costs associated with operating UE 102 on packet data network 110, or an operator of communication system 100 may be desirous of utilizing the already built-out circuit switched network 130 for whatever services may be supported by the circuit switched network. By way of yet other examples, for load balancing purposes or for congestion relief, the operator of communication system 100 may find it desirable to utilize circuit switched network 130 for a voice call or a voice portion of a communication session of a UE, such as UE 102, active in packet data network 110.

In order to facilitate an establishment, in circuit switched network 130, of a voice call or a voice portion of a communication session of a UE, such as UE 102, active in packet data network 110, communication system 100 implements a circuit switched fallback (CSFB) voice call establishment scheme. That is, as known in the art (for example, 3GPP Technical Specification (TS) 23.272), a communication system implementing both a packet data network and a circuit switched network may establish a voice call or voice portion of the communication session in the circuit switched network for a UE that is active in the packet data network. In addition, as part of its implementation of a CSFB scheme, communication system 100 implements CSFB services that support a CSFB scheme, such as UE registration in circuit switched network 130 via packet data network 110 and other messaging exchanged between the packet data network and the circuit switched network, such as message tunneling, for example, tunneling of voice communications or any other messaging in support of CSFB, between the circuit switched network and the packet data network. However, in the prior art, the packet data network typically does not know the level of congestion of the circuit switched network and, as a result, may attempt to establish a call in an already congested circuit switched network, which may produce excessive congestion in tunneling between a packet data network and a circuit switched network, may cause the call attempt to fail or the call to be dropped, and/or may detrimentally impact a quality of other on-going calls in the circuit switched network. In order to minimize the likelihood of such problems resulting from circuit switched fallback, communication system 100 controls an access to circuit switched network 130 by a UE active in packet data network 110.

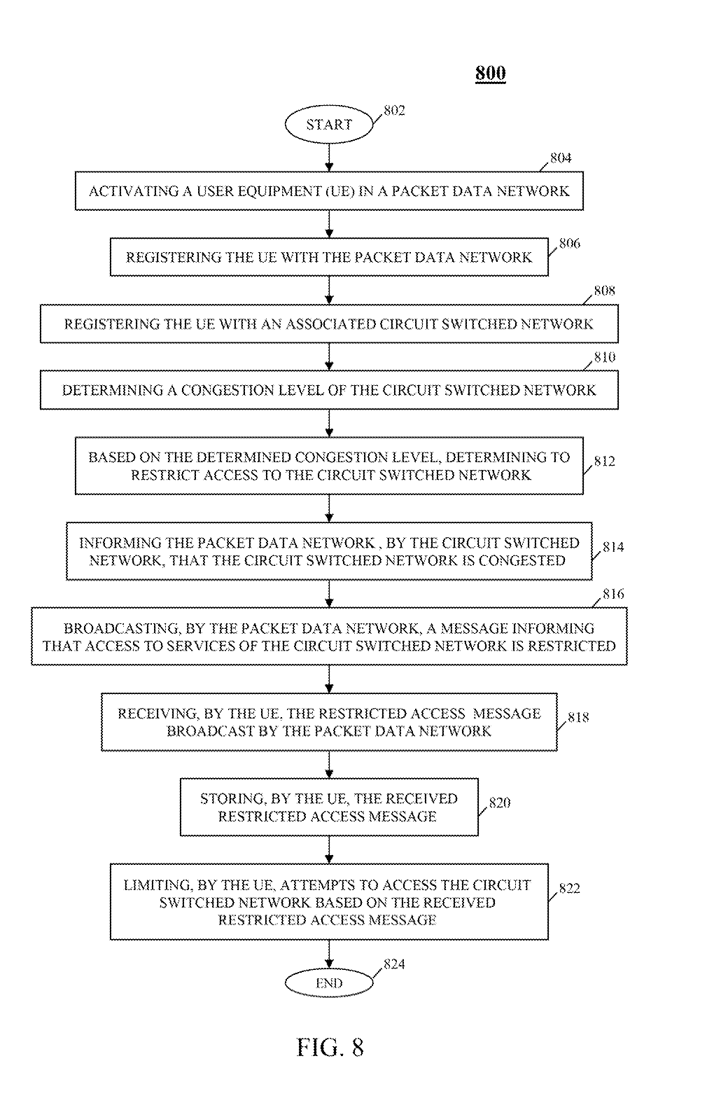

Referring now to FIG. 8, a logic flow diagram 800 is provided that illustrates a method executed by communication system 100 in controlling access to services of circuit switched network 130 by a UE, such as UE 102, active in packet data network 110 in accordance with various embodiments of the present invention. Logic flow diagram 800 begins (802) when UE 102 activates (804) in and connects with packet data network 110. For example, the activation may be a result of the UE powering up in packet data network 110 or may be a result of the UE roaming into the packet data network. As part of the activation process, the UE registers (806) with packet data network 110 and the packet data network, and in particular MME 120, then may register (808) the UE with associated circuit switched network 130, and in particular MSC138.

For example, the 3GPP standards (TS 23.272) provide a mechanism whereby a UE, such as UE 102, may request of a packet data network, such as packet data network 110, and in particular an MME of the packet data network, such as MME 120, that the UE be registered with both the packet data network and a corresponding circuit switched network, such as circuit switched network 130. Under the 3GPP standards, the MME acts as a Serving Gateway Support Node (SGSN) with respect to an MSC of the circuit switched network, so that the MSC thinks that the UE is attached to a circuit switched network rather than a packet data network and performs a location update via the perceived SGSN. More particularly, when the UE registers with the MME, the MME provides the UE with a packet data network location identifier, such as a Tracking Area Identifier for an LTE network. In turn, the MME maps the packet data network location area identifier to a circuit switched network location identifier, such as a Location Area Identifier, and provides the circuit switched network location identifier to an MSC of the circuit switched network, such as MSC 138.

At some point in time, prior to or subsequent to the activation of UE 102 in packet data network 110, IWS 122 determines (810) a congestion level associated with circuit switched network 130 and, based on the determined congestion level, determines (812) to restrict access of UEs active in packet data network 110, such as UE 102, to the services of circuit switched network 130.

That is, RAN 132, and in particular access node 134, monitors a congestion level of circuit switched network 130, and in particular, the coverage area of the access node. For example, the access node may determine a congestion level based on a channel availability at, or a quantity of UEs serviced by, the access node, or the access node may determine a congestion level based on a signal quality metric measured by the access node or measured by, and reported to, the access node by one or more UEs serviced by the access node. Exemplary signal quality metrics include, but are not limited to, a Signal to Interference-plus-Noise Ratio (SINR), a Carrier-to-Noise ratio (CIR), an energy per bit to noise power spectral density ratio (E_{b}/N₀), a bit error rate, or a frame error rate with respect to signals received by the access node. When IWS 122 is not included in the access node, the access node then may report the determined congestion level to the IWS. IWS 122 then may determine a congestion level for the entire area serviced by the IWS, for example, based on reports received from each access node of one or more access nodes served by the IWS, or may determine a congestion level for a portion of the coverage area, such as a particular cell or access node served by the IWS or a sector of a cell served by the IWS. Based on the determined congestion level, IWS 122 then triggers the activation of the access control mechanism. For example, IWS 122 may compare the determined congestion level to a congestion threshold maintained in the at least one memory device 604 of the IWS and, when the determined congestion level exceeds the congestion threshold, the IWS triggers the activation of the access control mechanism.

As part of the determination to restrict access of UEs active in packet data network 110 to the services of circuit switched network 130, IWS 122 may further determine, based on the congestion level, a level of restriction of access to the circuit switched network. That is, in determining to restrict access to the services of circuit switched network 130, IWS 122 further may determine one or more access-related parameters to be restricted, such as circuit switched network coverage areas and/or circuit switched network access nodes at which to restrict access and one or more classes of UEs, one or more types of service, and/or one or more classes of service that are being restricted. Based on the determined congestion level, IWS may determine a restriction level of such parameters, such as a quantity of circuit switched network coverage areas or circuit switched network access nodes at which to restrict access and/or a quantity of UE classes, service types, and/or classes of service that are restricted. The greater the congestion level, the greater the level of restriction of access, that is, the larger the quantity of circuit switched network coverage areas or circuit switched network access node and/or the quantity of UE classes, service types, and/or classes of service that are restricted. In determining the level of restriction of access, IWS 122 may compare the determined congestion level to one or more of multiple congestion thresholds maintained in the at least one memory device 604 of the IWS, wherein each higher threshold corresponds to a higher level of restriction of access to circuit switched network 130.

In response to triggering the activation of the access control mechanism, that is, in response to determining to restrict access of UEs active in packet data network 110 to the services of circuit switched network 130, circuit switched network 130 conveys (814) to packet data network 110, and the packet data network receives from the circuit switched network, a message indicating that the circuit switched network is congested. The message may further indicate the determined level of restriction of access, for example, identifying specific circuit switched network coverage areas and/or circuit switched network access nodes at which to restrict access and specific UE classes, service types, and/or a classes of service that are restricted. More particularly, IWS 122 conveys a congestion control message to packet data network 110 that informs that the circuit switched network is congested. In one embodiment of the present invention, IWS 122 may convey the congestion control message, for example, an A21-IWS Congestion Control message, to MME 120. In another embodiment of the present invention, IWS 122 may convey the congestion control message to access nodes, such as access node 114, of the packet data network (either via MME 120 or bypassing the MME) whose corresponding access node or coverage area of the circuit switched network, that is, access node 134 or coverage area 130, is determined to be congested.

In one embodiment of the present invention, the congestion control message may include one or more identifiers of circuit switched network coverage areas or circuit switched network access nodes, such as coverage area 131 and/or access node 134, where access to the services of circuit switched network 130 is being restricted. For example, the identifier may comprise a base station identifier, a sector identifier, a cell identifier, or a location area identifier associated with each congested circuit switched network coverage area/access node. The identifiers allow MME 120, by reference to database 506, to identify the packet data network access nodes, such as access node 114, serving the UEs that are being restricted. In another embodiment of the present invention, IWS 122 may include a database 606 similar to database 506, allowing the IWS to identify the packet data network access nodes associated with each congested circuit switched network coverage area/access node and to include an identifier of the packet data network access nodes in the congestion control message. In yet another embodiment of the present invention, when access of UEs in packet data network 110 is being restricted with respect to the entire service area of MME 120, then such identifiers may be omitted from the message altogether.

The congestion control message further includes an indication that access of UEs in packet data network 110 to one or more services of circuit switched network 130 is being restricted. For example, the indication may include one or more circuit switched network access restriction parameters that identify, for example, one or more classes of UEs, one or more types of service, and/or one or more classes of service that are being restricted by the circuit switched network. For example, the access restriction parameters may comprise access class barring (ACB) parameters that identify one or more classes of UEs and/or service classes, such as UE access classes or QoS classes for various types of traffic (for example, conversational class (voice, video telephony, video gaming), streaming class (multimedia, video on demand, webcast), interactive class (web browsing, network gaming, database access), and background class (email, SMS, downloading) traffic) as known in the art, that one or more of is barred from accessing circuit switched network 130 or whose access to circuit switched network is being reduced. For example, if the ACB parameters identify that voice traffic is being restricted, then circuit switched fallback correspondingly is restricted. The congestion control message may instead or additionally indicate services that support CSFB that are being restricted, for example, UE registration in circuit switched network 130 via packet data network 110 and other messaging exchanged between the packet data network and the circuit switched network, such as message tunneling, for example, tunneling of voice communications or any other messaging in support of CSFB, between the circuit switched network and the packet data network. In the instance that the message informs that access to circuit switched network is being reduced, as is described in greater detail below, the intention is that some, but fewer than all, UEs active in packet data network 110 and residing in a congested coverage area and/or at a congested access node of circuit switched network 130 will be allowed to access the circuit switched network.

In one embodiment of the present invention, the congestion control message includes a single set of ACB parameters that applies to all packet data network coverage areas/access nodes being controlled. In another embodiment of the present invention, the congestion control message may include multiple sets of ACB parameters, wherein each set of ACB parameters applies to one or more packet data network coverage areas/access nodes of multiple packet data network coverage areas/access nodes being controlled. In still another embodiment of the present invention, when multiple packet data network coverage areas/access nodes are being controlled, a separate congestion control message and set of ACB parameters may be sent for each packet data network coverage area/access node of the multiple packet data network coverage areas/access nodes being controlled. When access to one or more circuit switched network coverage areas/access nodes is being reduced, as opposed to being barred, the congestion control message further includes, in association with each set of ACB parameters, an indicator, such as a flag, that access to the packet data network coverage areas/access nodes corresponding to the set of ACB parameters is being reduced. For example, when the flag is set, then access is being reduced, and when there is no flag, then access is being barred.

In response to receiving the congestion control message, packet data network 110 broadcasts (816) a message informing that access to one or more services of circuit switched network 130 is being restricted. More particularly, in response to receiving the congestion control message from IWS 122, MME 120 processes the received congestion control message. In response to receiving the congestion control message and by reference to database 506 maintained by the MME, MME 120 assembles and conveys, to one or more packet data network access nodes, such as access node 114, a first packet data network congestion control message to each access node of packet data network 110 served by the IWS or to the packet data network access nodes identified by the congestion control message received by the MME, instructing the access nodes to broadcast a message informing that access to one or more services of circuit switched network 130 is being restricted. For example, the first packet data network congestion control message may be a modified version of an MME Direct Information Transfer message, which message is modified to include information elements (IEs) that identify the coverage areas or circuit switched network access nodes where access to one or more services of circuit switched network 130 is being restricted and that include the one or more access restriction parameters, such as ACB parameters, that identify, for example, one or more UE classes or service classes whose access is being restricted. In various embodiments of the present invention, the access restriction parameters included in the IEs may be the circuit switched network access restriction parameters received from IWS 122 or MME 120 may translate the circuit switched network access restriction parameters to corresponding packet data network access restriction parameters, based on a mapping maintained in the at least one memory device 504 of the MME, and include the corresponding packet data network access restriction parameters in the IEs.

In one such embodiment of the present invention, in response to receiving the congestion control message from IWS 122, MME 120 may convey the first packet data network congestion control message to all packet data network access nodes served by the MME. That is, as described above, the congestion control message received by the MME may include one or more identifiers of circuit switched network coverage areas or circuit switched network access nodes, such as coverage area 131 and/or access node 134, where access to the services of circuit switched network 130 is being restricted. Based on these identifiers, MME 120, by reference to database 506, identifies the packet data network access nodes, such as access node 114, serving the UEs that are being restricted and includes identifiers associated with the packet data network access nodes, such as a base station identifier, a sector identifier, a cell identifier, or a tracking area identifier, in the first packet data network congestion control message. The MME then conveys the first packet data network congestion control message to packet data network access nodes, such as access node 114, whose coverage area 111 substantially corresponds with the identified one or more coverage areas or access nodes of the circuit switched network 130, that is coverage area 131 and access node 134, and access nodes of the packet data network 130 whose coverage area does not substantially correspond with the identified one or more coverage areas or access nodes of the circuit switched network, that access to one or more services of the circuit switched network is restricted. Based on the included identifiers, each packet data network access node that is an intended recipient of the first packet data network congestion control message is able to determine that it is an intended recipient and, in response to receiving the first packet data network congestion control message, broadcasts (816) a second packet data network congestion control message as described in greater detail below.

In another such embodiment of the present invention, in response to receiving the congestion control message from IWS 122, MME 120 determines whether the MME serves any of the packet data network access nodes identified by the congestion control message. If the MME does not serve any identified packet data network access node, the MME may discard the message. If the MME serves one or more identified packet data network access nodes, the MME conveys the first packet data network congestion control message only to identified packet data network access nodes served by the MME, such as access node 114, which then broadcast (816) a second packet data network congestion control message as described in greater detail below (without a need to first determine that each such access node is an intended recipient of the first packet data network congestion control message).

When a broadcasting packet data network access node, such as access node 114, receives the first packet data network congestion control message from MME, the access node assembles and broadcasts a second packet data network congestion control message. The second packet data network congestion control message informs UEs, such as UE 102, served by the access node that access to circuit services network 130 is being restricted and may or may not be the same message as the first packet data network congestion control message. The second packet data network congestion control message may block all access to circuit switched network 130 or may restrict access in a more limited way, for example, by identifying restricted UEs classes, services, and/or service types. For example, the second packet data network congestion control message may include circuit switched network access restriction parameters or packet data network access restriction parameters, that is, whichever type of access restriction parameters were received by the packet data network access node. In one embodiment of the present invention, when restricted access to circuit services network 130 is not limited to any particular circuit services network coverage area, such as sector or cell, serviced by the packet data network access node, the packet data access node may broadcast the second packet data network congestion control message in all coverage areas serviced by the packet data network access node. In another embodiment of the present invention, when restricted access to circuit services network 130 is limited to one or more particular circuit services network coverage areas/access nodes associated with the packet data network access node, such as one or more sectors, the packet data network access node may broadcast the second packet data network congestion control message only in coverage areas serviced by the packet data network access node and associated with the particular circuit services network coverage areas/access nodes. In still other embodiments of the present invention, the second packet data network congestion control message may further include packet data network sector or cell identifiers identifying restricted areas.

When a UE, such as UE 102, receives (818) the restricted access message broadcast by packet data network 110, that is, the second packet data network congestion control message, the UE stores (820) the message in the at least one memory device 204 of the UE and limits (822) any attempt to access circuit switched network 130 based on the information included in the message. Logic flow diagram 800 then ends (824). For example, if the message informs that access to circuit switched network is being barred for identified classes of UE or types of traffic, the UE refrains from attempting to access circuit switched network 130 if the UE is of the indentified class or seeks to transmit the identified types of traffic. In another embodiment, if the message merely seeks to reduce access to circuit switched network for identified classes of UE or types of traffic, then when the UE desires to access circuit switched network 130 and the UE is of the indentified class or seeks to transmit the identified types of traffic, the UE executes a ‘reduced access’ algorithm maintained in the at least one memory device 204 of the UE to determine whether it may access circuit switched network 130. For example, such an algorithm may comprise generating a random number and comparing the random number to a random number threshold. When the random number exceeds the threshold, then the UE determines that it may access circuit switched network 130; however, when the random number is less than the threshold, then the UE determines that it is barred from accessing the circuit switched network.

Subsequent to restricting access to the services of circuit switched network 130, communication system 100 may desire to allow for a resumption of such access. In one such embodiment of the present invention, each congestion control message may restrict access only for a limited period of time. When a UE, such as UE 102, receives the second packet data network congestion control message, the UE may activate a restricted access timer 210 coupled to the processor 202 of the UE. Restricted access timer 210 counts down a predetermined period of time, maintained by at least one memory device 204, during which the UE is restricted in its access to circuit switched network 130. When the timer expires, the UE may again access the circuit switched network in an unrestricted manner.

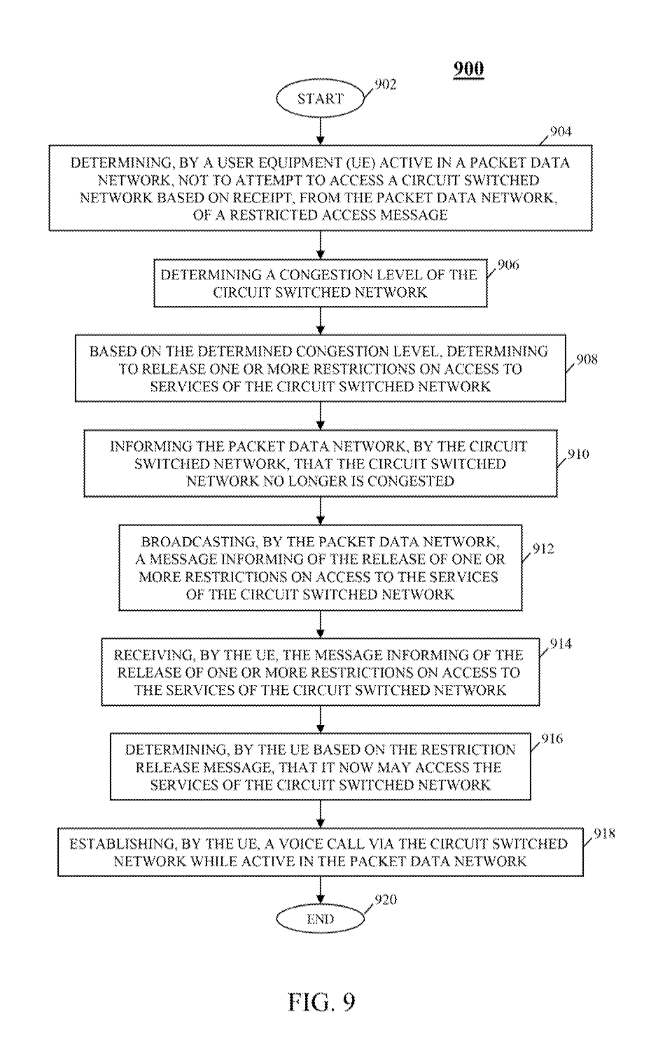

In another embodiment of the present invention, communication system 100 may provide for a resumption of such access in a restricted coverage or at a restricted access node by broadcasting a message informing of a resumption of such access Referring now to FIG. 9, a logic flow diagram 900 is provided that illustrates a method executed by communication system 100 in providing for a release of restricted access to services of circuit switched network 130 by a UE active in packet data network 110 in accordance with various embodiments of the present invention.

Logic flow diagram 900 begins (902) when a UE, such as UE 102, determines (904), in response to receiving a restricted access message, to not attempt to access circuit switched network 130. Circuit switched network 130, and in particular IWS 122, the determines (906) a congestion level associated with the circuit switched network, as described with respect to step 810 above, and based on the determined congestion level, determines (908) to release one or more restrictions on access to circuit switched network services in one or more circuit switched network coverage areas or at one or more circuit switched network access nodes, by UEs active in packet data network 110, such as UE 102. In response to determining to resume provision of circuit switched network services to UEs active in packet data network 110, circuit switched network 130 conveys (910), to packet data network 110, a message indicating that the circuit switched network no longer is congested. For example, IWS 122 may convey, to the packet data network and in particular to MME 120, a restriction release message informing of the release of one or more restrictions on access to services of the circuit switched network. In one embodiment of the present invention, IWS 122 may convey the restriction release message, for example, an A21-IWS Restricted Access Release message, to MME 120. In response to receiving the restriction release message, MME 120 instructs the corresponding packet data access nodes, such as access node 114, where the restrictions are being released to broadcast a message informing that access to the one or more formerly restricted services of the circuit switched network no longer is restricted. In another embodiment of the present invention, IWS 122 may convey the restriction release message to access nodes, such as access node 114, of the packet data network (either via MME 120 or bypassing the MME) whose corresponding access node or coverage area of the circuit switched network, that is, access node 134 or coverage area 130, is determined to no longer be congested.

In one embodiment of the present invention, the restriction release message may include one or more identifiers of circuit switched network coverage areas or circuit switched network access nodes, such as coverage area 131 and/or access node 134, where the restriction of access to the services of circuit switched network 130 is being released. For example, the identifier may comprise a base station identifier, a sector identifier, a cell identifier, or a location area identifier associated with each congested circuit switched network coverage area/access node. The identifiers allow MME 120, by reference to database 506, to identify the packet data network access nodes, such as access node 114, serving the UEs where the restrictions on access to the services of circuit switched network 130 are being released. In another embodiment of the present invention, IWS 122 may include a database 606 similar to database 506, allowing the IWS to identify the packet data network access nodes associated with each formerly congested circuit switched network coverage area/access node and to include an identifier of the packet data network access nodes in the congestion control message. In yet another embodiment of the present invention, when the restricted access of UEs in packet data network 110 is being released with respect to the entire service area of MME 120, then such identifiers may be omitted from the message altogether. The release message may further include one or more ACB parameters that identify one or more UE classes or service classes, whose restricted access to circuit switched network 130 is being released.

In response to receiving the release message, packet data network access node 114 assembles and broadcasts (912) a packet data message informing of the release of one or more restrictions on access to the services of circuit switched network 130, for example, a packet data network restriction release message informing UEs, such as UE 102, served by the access node that restricted access to circuit services network 130 is being released. When UE 102 receives (914) the message, the UE determines (916) that it may now access the services of circuit switched network 130 and, when next setting up a voice call or a communication session involving a voice call while the UE is active in packet data network 110, establishes (918) the voice call via circuit switched network 130. Logic flow diagram 900 then ends (920).

By providing packet data network 110 with information concerning areas and/or services of circuit switched network 130 that are subject to access restrictions, which information then is used by the packet data network to control access to the circuit switched network of UEs being served by the packet data network, communication system 100 is able to alleviate or prevent congestion in the circuit switched network resulting from such UEs attempting to access the circuit switched network to obtained circuit switched network services, including CSFB. Restricting the attempts of such UEs to access circuit switched network 130 further alleviates or prevents congestion with respect to message tunneling between the two networks that may result from such UEs registering with, or establishing a communication session in, the circuit switched network. Communication system 100 further provides for graduated levels of restriction of access to circuit switched network 130, where a quantity of restricted areas of circuit switched network and/or a quantity of UE classes, service types, and/or classes of service that are restricted may be adjusted based on a determined congestion level of the circuit switched network.

To facilitate a determination, by packet data network 110, of which UEs served by the packet data network are impacted by the access restrictions, communication system 100 also provides for a translation of the restricted circuit switched network coverage areas and/or access nodes to substantially corresponding packet data network coverage areas and/or access nodes. Additionally, in various embodiments of the present invention, communication system 100 provides for MME 120 or the packet data access nodes to be a filtering point for a distribution of a congestion control message. That is, in one such embodiment, MME 120 selectively conveys congestion control messages only to packet data network access nodes corresponding to restricted circuit switched network coverage areas and/or access nodes and all recipient access nodes then broadcast a congestion control message; while in another such embodiment, the MME conveys congestion control messages to all packet data network access nodes served by the MME and each such packet data network access node determines, in response to receiving the message, whether it is associated with a restricted area and is to broadcast a congestion control message.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for controlling network access in a multi-technology wireless communication system comprising a packet data network and a circuit switched network, the method comprising:
serving, by the packet data network, a user equipment;
receiving, by the packet data network from the circuit switched network, an indication that the circuit switched network is congested; and
broadcasting, by the packet data network, a message informing that access to one or more services of the circuit switched network is restricted.

2. The method of claim 1, wherein receiving an indication that the circuit switched network is congested comprises receiving a message that identifies one or more access restriction parameters of the circuit switched network, and wherein broadcasting a message informing that access to one or more services of the circuit switched network is restricted comprises broadcasting, by the packet data network, a message comprising the access restriction parameters of the circuit switched network.

3. The method of claim 1, further comprising:
determining a congestion level of the circuit switched network;
based on the determined congestion level, determining to restrict access to the circuit switched network;
informing the packet data network, by the circuit switched network, that the circuit switched network is congested.

4. The method of claim 3, wherein determining to restrict access to the circuit switched network comprises determining a level of restriction of access that will reduce congestion and wherein informing that the circuit switched network is congested comprises conveying an indication of the level of restriction of access.

5. The method of claim 3, wherein determining to restrict access to the circuit switched network comprises determining to restrict access to the circuit switched network for one or more circuit switched fallback services.

6. The method of claim 1, wherein receiving an indication that the circuit switched network is congested comprises receiving an A21-IWS Congestion Control message informing that the circuit switched network is congested.

7. The method of claim 1, wherein receiving an indication that the circuit switched network is congested comprises receiving, by one or more of an access node and a Mobility Management Entity of the packet data network from an Interworking Solution Function of the circuit switched network, a message informing that the circuit switched network is congested.

8. The method of claim 1, wherein receiving an indication that the circuit switched network is congested comprises receiving, by a Mobility Management Entity of the packet data network, the message indicating that the circuit switched network is congested, and wherein broadcasting, by the packet data network, a message informing that access to one or more services of the circuit switched network is restricted comprises:
in response to receiving the message by the Mobility Management Entity, informing an access node of the packet data network, by the Mobility Management Entity, that access to one or more services of the circuit switched network is being restricted; and
broadcasting, by the access node, a message informing that access to one or more services of the circuit switched network is restricted.

9. The method of claim 1, wherein receiving an indication that the circuit switched network is congested comprises receiving a message that identifies one or more classes of user equipment or service classes that are one or more of being barred from accessing the circuit switched network or whose access to the circuit switched network is being reduced.

10. The method of claim 1, wherein receiving an indication that the circuit switched network is congested comprises receiving a message that identifies one or more coverage areas or access nodes of the circuit switched network where access to the circuit switched network is being restricted.

11. The method of claim 10, wherein broadcasting, by the packet data network, a message informing that access to one or more services of the circuit switched network is restricted comprises:
informing only access nodes of the packet data network whose coverage area substantially corresponds with the identified one or more coverage areas or access nodes of the circuit switched network, that access to one or more services of the circuit switched network is being restricted; and
broadcasting, by the informed access nodes of the packet data network, a message informing that access to one or more services of the circuit switched network is restricted.

12. The method of claim 10, wherein broadcasting, by the packet data network, a message informing that access to one or more services of the circuit switched network is restricted comprises:
informing access nodes of the packet data network whose coverage area substantially corresponds with the identified one or more coverage areas or access nodes of the circuit switched network and access nodes of the packet data network whose coverage area does not substantially correspond with the identified one or more coverage areas or access nodes of the circuit switched network, that access to one or more services of the circuit switched network is restricted; and
broadcasting, only by the access nodes of the packet data network whose coverage area substantially corresponds with the identified one or more coverage areas or access nodes of the circuit switched network, a message informing that access to one or more services of the circuit switched network is restricted.

13. The method of claim 1, further comprising:
receiving, by the packet data network from the circuit switched network, an indication that the circuit switched network no longer is congested; and
broadcasting, by the packet data network, a message informing that access to the one or more services of the circuit switched network no longer is restricted.

14. A method for controlling network access in a multi-technology wireless communication system comprising a packet data network and a circuit switched network, the method comprising:
receiving from the packet data network, by a user equipment active in the packet data network, a message informing that access to one or more services of the circuit switched network is restricted; and
in response to receiving the message, limiting, by the user equipment, attempts to establish a voice call via the circuit switched network.

15. An apparatus that controls network access in a multi-technology wireless communication system comprising a packet data network and a circuit switched network, the apparatus comprising:
an at least one memory device configured to maintain a list of packet data network access nodes and a mapping of one or more of coverage areas and access nodes of the circuit switched network to corresponding coverage areas and access nodes of the packet data network;
a processor configured to receive, in the packet data network and from the circuit switched network, a message indicating that the circuit switched network is congested and, in response to receiving the message, convey a message to an access node of the packet data network instructing the access node to broadcast a message informing that access to one or more services of the circuit switched network is restricted.

16. The apparatus of claim 15, wherein the processor is configured to receive an indication that the circuit switched network is congested by receiving a message that identifies one or more access restriction parameters of the circuit switched network, and wherein the processor is configured to convey a message instructing that access to one or more services of the circuit switched network is restricted by conveying a message comprising the access restriction parameters of the circuit switched network.

17. The apparatus of claim 15, wherein the message indicating that the circuit switched network is congested comprises an indication of a level of restriction of access.

18. The apparatus of claim 15, wherein the message received by the processor restricts access to the circuit switched network for one or more circuit switched fallback services.

19. The apparatus of claim 15, wherein the processor is configured to receive a message indicating that the circuit switched network is congested by receiving an A21-IWS Congestion Control message informing that the circuit switched network is congested.

20. The apparatus of claim 15, wherein the an at least one memory device and the processor are included in a Mobility Management Entity, wherein the apparatus further comprises the access node of the packet data network, and wherein the access node, in response to receiving the message instructing the access node to broadcast a message informing that access to one or more services of the circuit switched network is restricted, broadcasts a message informing that access to one or more services of the circuit switched network is restricted.

21. The apparatus of claim 15, wherein the message indicating that the circuit switched network is congested comprises a message including one or more access class barring parameters that identify one or more classes of user equipment or service classes that are one or more of being barred from accessing the circuit switched network or whose access to the circuit switched network is being reduced.

22. The apparatus of claim 15, wherein the message indicating that the circuit switched network is congested comprises a message that identifies one or more coverage areas or access nodes of the circuit switched network where access to the circuit switched network is being restricted.

23. The apparatus of claim 22, wherein the processor is configured to convey a message to an access node of the packet data network instructing the access node to broadcast a message informing that access to one or more services of the circuit switched network is restricted by conveying the message to access nodes of the packet data network whose coverage area substantially corresponds with the identified one or more coverage areas or access nodes of the circuit switched network and to access nodes of the packet data network whose coverage area does not substantially correspond with the identified one or more coverage areas or access nodes of the circuit switched network, that access to one or more services of the circuit switched network is restricted and including the translated the one or more coverage areas or access nodes in the message.

24. The apparatus of claim 22, wherein the processor is configured to convey a message to an access node of the packet data network instructing the access node to broadcast a message informing that access to one or more services of the circuit switched network is restricted by conveying the message only to access nodes of the packet data network whose coverage area substantially corresponds with the identified one or more coverage areas or access nodes of the circuit switched network, that access to one or more services of the circuit switched network is being restricted.

25. The apparatus of claim 15, wherein the message conveyed to the access node comprises an MME Direct Information Transfer message that identifies one or more circuit switched network coverage areas or access nodes where access to one or more services of the circuit switched network is being restricted and that comprises one or more access class barring parameters.

26. The apparatus of claim 15, wherein the processor further is configured to receive, from the circuit switched network, an indication that the circuit switched network no longer is congested and, in response to receiving the indication that the circuit switched network no longer is congested, instruct the access node to broadcast a message informing that access to the one or more services of the circuit switched network no longer is restricted.

27. A user equipment capable of operating in a multi-technology wireless communication system comprising a packet data network and a circuit switched network, the user equipment comprising a processor configured to, when active in the packet data network, receive from the packet data network a message informing that access to one or more services of the circuit switched network is restricted and, in response to receiving the message, limit attempts to establish a voice call via the circuit switched network.
